(19) United States
(12) Patent Application Publication
(10) Pub. No.: US 2025/0234803 A1
(43) Pub. Date: Jul. 24, 2025

(54) Control Systems and Methods for Self-Propelled Windrowers

(71) Applicant: AGCO Corporation, Duluth, GA (US)

(72) Inventors: Friedrich Robert Honeyman, Hesston, KS (US); Benjamin Adam Welle, Hesston, KS (US); Brendon C. Nafziger, Hesston, KS (US)

(21) Appl. No.: 18/698,467

(22) PCT Filed: Sep. 12, 2022
(86) PCT No.: PCT/IB2022/058586

§ 371 Date: Apr. 4, 2024

Related U.S. Application Data
(60) Provisional application No. 63/262,678, filed on Oct. 18, 2021.

(51) Int. Cl. A01D 41/127; A01D 41/02; F16H 59/24

(52) U.S. Cl. CPC A01D 41/1274; A01D 41/02; F16H 59/24

(57) ABSTRACT

Described herein are control systems and methods for self-propelled windrowers and other types of agricultural dual-path machines that improve drive efficiency of the machines through automated control of propulsion, steering, or engine speed. In some embodiments, a control system improves drive efficiency by adjusting engine speed and pressure and flow of a hydraulic propulsion system. In such embodiments and others, a controller controls the engine speed and pressure and flow of the hydraulic propulsion system in left and right drive pumps and motors of the dual-path machine according to setpoints and adjustment factors. The adjustment factors in such examples and others are not allowed to exceed respective thresholds, such as a fixed percentage of a raw command, to prohibit immobilizing the machine while disabling or limiting the controller. The adjustment factors are based on feedback signals from various sensors of the machine.

### TECHNICAL FIELD

The present disclosure relates to control systems and methods for agricultural dual-path machines, such as self-propelled windrowers.

### BACKGROUND

Dual-path machines, such as windrowers, are typically driven on uneven and sometimes muddy surfaces. Without a positively-controlled steered axle, a dual-path machine relies on traction to perform both propulsion and steering. Loose gravel and mud can slow the responsiveness of the drive train. If an operator applies too much acceleration or too rapid of steering for the ground conditions at that time, machine motion can be less than expected. In the condition that a machine is brought to a stop in mud, and one of the driven tires becomes stuck, there is a chance that the machine will pivot around the stuck tire. This is possible because rear casters will pivot to allow full range of motion.

Some dual-path agricultural machines include hydraulic damping steer-assist systems coupled to their caster wheels. However, these systems only smooth out motion and do not assist in conditions where loss of traction on one tire causes machine motion to not match the steering input. A positively-controlled steered caster can allow a machine to redirect tractive effort to overcome a stuck tire. Current positively-controlled steering systems must be manually engaged and disengaged, which hinders maneuverability in field conditions.

Also, when driving a dual-path machine such as a windrower, normally the throttle is set to full engine speed to ensure full range of the propulsion system. Adjusting the throttle while in transit will change the operating speed. At low speed conditions this results in unnecessary use of fuel. Additionally, the propulsion system tends to have less efficiency at lower loads.

### SUMMARY

Described herein are control systems and methods (techniques) for agricultural dual-path machines (such as self-propelled windrowers). For example, described herein are control systems and methods for self-propelled windrowers and other types of agricultural dual-path machines that improve drive efficiency of the machines through automated control of propulsion, steering, or engine speed. In some embodiments, a control system (which is a semi-closed loop control system in some embodiments or a closed loop control system in some other embodiments) improves drive efficiency by adjusting engine speed and pressure and flow of a hydraulic propulsion system. In such embodiments and others, a controller controls the engine speed and pressure and flow of the hydraulic propulsion system in left and right drive pumps and motors of the dual-path machine according to setpoints and adjustment factors. The adjustment factors in such examples and others are not allowed to exceed respective thresholds, such as a fixed percentage of a raw command, to prohibit immobilizing the machine while disabling or limiting the controller. The adjustment factors are based on feedback signals from various sensors of the machine.

In some embodiments, computing within a control system provides better drive efficiency through semi-closed-loop or closed-loop control propulsion, steering, and engine speed. This automatically optimizes the engine speed, propulsion system's pressure and flow for the needs at that moment. Headroom is left for rapid changes in speed or steering, as well as changes in load from a harvesting component. And, such computing can improve upon fuel efficiency by limiting the unnecessary use of fuel at low speed conditions. Additionally, such computing can improve upon the propulsion system, which tends to have less efficiency at lower loads.

In general, described herein are control systems and methods for self-propelled agricultural machines that improve efficiency of the machines through automated control of propulsion, steering, powered implement work, or engine speed. In some embodiments, a control system improves drive efficiency by adjusting engine speed and pressure and flow of a hydraulic propulsion system. In such embodiments and others, a controller controls the engine speed and pressure and flow of the hydraulic propulsion system in left and right drive pumps and motors of the dual-path machine according to setpoints and adjustment factors. The adjustment factors in such examples and others are not allowed to exceed respective thresholds, such as a fixed percentage of a raw command, to prohibit immobilizing the machine while disabling or limiting the controller. The adjustment factors are based on feedback signals from various sensors of the machine.

In some embodiments, a steering command and drive command are taken from a user via a steering wheel position sensor and a forward-neutral-reverse (FNR) stick position sensor. Park and seat safety inhibits can override such commands. Left and right propulsion setpoints are calculated from the sensors, in such an example. The setpoints can be based on an algorithm where steering sets a rate of absolute azimuth change and FNR provides a tangential velocity input. In such an example, left and right drive pumps and motors are commanded according to the calculated setpoints and the adjustment factors for enhanced flow and pressure. These compensation factors are prevented from exceeding a fixed percentage of the raw command. This can guarantee that a sensor failure would not immobilize the machine, but instead, only disable the pressure control system. The compensation factors include feedback from the motor pressure sensors, wheel speed sensors, engine load, header speed, header pressure, and optionally, feedback from any other relevant sources.

In providing techniques for agricultural dual-path machines, the systems and methods described herein overcome some technical problems in dual-path machines. Also, the techniques disclosed herein provide specific technical solutions to at least overcome the technical problems mentioned in the background section and other parts of the application as well as other technical problems not described herein but recognized by those skilled in the art.

With respect to some embodiments, disclosed herein are computerized methods for enhancing control systems of dual-path machines, as well as a non-transitory computer-readable storage medium for carrying out technical operations of the computerized methods. The non-transitory computer-readable storage medium has tangibly stored thereon, or tangibly encoded thereon, computer readable instructions that when executed by one or more devices (e.g., one or more personal computers or servers) cause at least one processor to perform a method for enhancing control systems of dual-path machines.

For example, in some embodiments, a method includes receiving, by an electronic system (which can include a computing system), a throttle input for operating a drive system of an agricultural dual-path machine. The drive system includes a left-side drive system including a left drive pump and a left motor and a right-side drive system including a right drive pump and a right motor. The method also includes determining, by the electronic system, adjustment factors for adjusting setpoints for operating the drive system, based on feedback from sensors of the agricultural dual-path machine. The method also includes controlling, by the electronic system, an augmenting control system to control operations of the drive system based on the received throttle input, the setpoints, and the adjustment factors.

In some embodiments, the agricultural dual-path machine is a self-propelled windrower.

In some embodiments, the setpoints include torque-to-speed ratios. In some embodiments, the left drive pump and right drive pump are variable-displacement pumps, and wherein the left motor and the right motor are variable-displacement motors.

In some embodiments, the method further includes disabling, by the electronic system, the augmenting control system to control operations of the drive system based only on the throttle input and the setpoints when an adjustment factor of the adjustment factors exceeds a corresponding adjustment factor threshold.

In some embodiments, the method further includes limiting, by the electronic system, the augmenting control system to control operations of the drive system based on the received throttle input, the setpoints, and a subset of the adjustment factors, when an adjustment factor of the adjustment factors exceeds a corresponding adjustment factor threshold. In some examples, the subset of the adjustment factors excludes the adjustment factor that exceeded its corresponding adjustment factor threshold.

In some embodiments, the method further includes retrieving, by the electronic system, a safety input upon receiving the throttle input. In such examples, the method includes overriding, by the electronic system, the throttle input when the retrieved safety input includes a safety violation signal, and accepting, by the electronic system, the throttle input when the retrieved safety input includes an acceptable safety signal. Also, in such examples, the method includes controlling, by the electronic system, the augmenting control system to control operations of the drive system based on the received and accepted throttle input, the setpoints, and the adjustment factors. In such embodiments and others, the method includes disabling, by the electronic system, the augmenting control system to control operations of the drive system based only on the throttle input and the setpoints when an adjustment factor of the adjustment factors exceeds a corresponding adjustment factor threshold. Alternatively, in such embodiments and others, the method includes limiting, by the electronic system, the augmenting control system to control operations of the drive system based on the received throttle input, the setpoints, and a subset of the adjustment factors, when an adjustment factor of the adjustment factors exceeds a corresponding adjustment factor threshold. In some examples, the subset of the adjustment factors excludes the adjustment factor that exceeded its corresponding adjustment factor threshold.

With respect to some embodiments, the techniques include a non-transitory computer readable storage medium including computer program instructions configured to instruct a computer processor to perform at least the steps of: receiving, by a computing system, a throttle input for operating a drive system of an agricultural dual-path machine (the drive system including: a left-side drive system including a left drive pump and a left motor; and a right-side drive system including a right drive pump and a right motor); determining, by the computing system, adjustment factors for adjusting setpoints for operating the left drive pump, the left motor, the right drive pump, and the right motor, based on feedback from sensors of the agricultural dual-path machine; and controlling, by the computing system, an augmenting control system to control operations of the left drive pump, the left motor, the right drive pump, and the right motor based on the received throttle input, the setpoints, and the adjustment factors.

In some embodiments of the non-transitory computer readable storage medium, the setpoints include torque-to-speed ratios. In some embodiments, the left drive pump and the right drive pump are variable-displacement pumps, the left motor and the right motor are variable-displacement motors. In some embodiments, the steps performed further include disabling, by the computing system, the augmenting control system to control operations of the left drive pump, the left motor, the right drive pump, and the right motor based only on the throttle input and the setpoints when an adjustment factor of the adjustment factors exceeds a corresponding adjustment factor threshold. In some embodiments, the steps performed further include limiting, by the computing system, the augmenting control system to control operations of the left drive pump, the left motor, the right drive pump, and the right motor based on the received throttle input, the setpoints, and a subset of the adjustment factors, when an adjustment factor of the adjustment factors exceeds a corresponding adjustment factor threshold. In some embodiments, the subset of the adjustment factors excludes the adjustment factor that exceeded its corresponding adjustment factor threshold. In some embodiments, the steps performed further include: retrieving, by the computing system, a safety input upon receiving the throttle input; overriding, by the computing system, the throttle input when the retrieved safety input includes a safety violation signal; accepting, by the computing system, the throttle input when the retrieved safety input includes an acceptable safety signal; and controlling, by the computing system, the augmenting control system to control operations of the left drive pump, the left motor, the right drive pump, and the right motor based on the received and accepted throttle input, the setpoints, and the adjustment factors. In such embodiments and others, the steps further include limiting, by the computing system, the augmenting control system to control operations of the left drive pump, the left motor, the right drive pump, and the right motor based on the received throttle input, the setpoints, and a subset of the adjustment factors, when an adjustment factor of the adjustment factors exceeds a corresponding adjustment factor threshold, and wherein the subset of the adjustment factors excludes the adjustment factor that exceeded its corresponding adjustment factor threshold.

With respect to some embodiments, the techniques include a computing device, including: at least one processor; and a storage medium tangibly storing thereon program logic configured to instruct the at least one processor to at least: receive a throttle input for operating a drive system of a self-propelled windrower (the drive system including: a left-side drive system including a left drive pump and a left motor; and a right-side drive system including a right drive pump and a right motor); determine adjustment factors for adjusting setpoints for operating the drive system, based on feedback from sensors of the self-propelled windrower; and control an augmenting control system to control operations of the drive system based on the received throttle input, the setpoints, and the adjustment factors.

Some embodiments are applicable to other agricultural machines in general. For example, in some embodiments, a generalized method includes receiving, by an electronic system, a throttle input for operating a drive system of an agricultural dual-path machine The drive system including a hydraulic system that includes at least one hydraulic drive pump and at least one hydraulic motor. The method also includes: determining, by the electronic system, adjustment factors for adjusting setpoints for operating the hydraulic system, based on feedback from sensors of the agricultural dual-path machine; and controlling, by the electronic system, an augmenting control system to control operations of the hydraulic system based on the received throttle input, the setpoints, and the adjustment factors. In some embodiments, the agricultural dual-path machine is a self-propelled windrower. In some other embodiments, the dual-path machine is a harvester such as a combine harvester. In such examples of a harvester, the harvester can bias the hydraulics of one system to be more efficient than another based on operating conditions, which could for instance reduce the slug tolerance for the sake of efficiency or acceleration or decrease the grade tolerance to improve torque input to control system.

In some embodiments of the general method, the setpoints include torque-to-speed ratios. Also, in some instances, the at least one hydraulic drive pump is a variable-displacement pump, and the at least one hydraulic motor is a variable-displacement motor.

In some embodiments of the general method, the method includes disabling, by the electronic system, the augmenting control system to control operations of the drive system based only on the throttle input and the setpoints when an adjustment factor of the adjustment factors exceeds a corresponding adjustment factor threshold. In some other embodiments, the method includes limiting, by the electronic system, the augmenting control system to control operations of the drive system based on the received throttle input, the setpoints, and a subset of the adjustment factors, when an adjustment factor of the adjustment factors exceeds a corresponding adjustment factor threshold. In some examples, the subset of the adjustment factors excludes the adjustment factor that exceeded its corresponding adjustment factor threshold.

In some embodiments of the general method, the method includes: retrieving, by the electronic system, a safety input upon receiving the throttle input; overriding, by the electronic system, the throttle input when the retrieved safety input includes a safety violation signal; accepting, by the electronic system, the throttle input when the retrieved safety input includes an acceptable safety signal; and controlling, by the electronic system, the augmenting control system to control operations of the drive system based on the received and accepted throttle input, the setpoints, and the adjustment factors. In such embodiments and others, the method includes disabling, by the electronic system, the augmenting control system to control operations of the drive system based only on the throttle input and the setpoints when an adjustment factor of the adjustment factors exceeds a corresponding adjustment factor threshold. Alternatively, the method includes limiting, by the electronic system, the augmenting control system to control operations of the drive system based on the received throttle input, the setpoints, and a subset of the adjustment factors, when an adjustment factor of the adjustment factors exceeds a corresponding adjustment factor threshold. In some instances, the subset of the adjustment factors excludes the adjustment factor that exceeded its corresponding adjustment factor threshold.

In some embodiments, the generalized method and its variations are performed by execution of computer program instructions. More specifically, in some embodiments, a non-transitory computer readable storage medium including computer program instructions is configured to instruct a computer processor to perform at least the steps of the aforementioned generalized method and its variations.

In some embodiments, the generalized method and its variations are implemented via a processor. For example, in some embodiments, an electronic device includes at least one processor and a storage medium tangibly storing thereon program logic configured to instruct the at least one processor to: receive a throttle input for operating a drive system of a dual-path agricultural machine (the drive system including a hydraulic system including at least one hydraulic drive pump and at least one hydraulic motor); determine adjustment factors for adjusting setpoints for operating the drive system, based on feedback from sensors of the dual-path agricultural machine; and control an augmenting control system to control operations of the drive system based on the received throttle input, the setpoints, and the adjustment factors.

These and other important aspects of the invention are described more fully in the detailed description below. The invention is not limited to the particular methods and systems described herein. Other embodiments can be used and changes to the described embodiments can be made without departing from the scope of the claims that follow the detailed description.

### BRIEF DESCRIPTION OF THE DRAWINGS

The present disclosure will be understood more fully from the detailed description given below and from the accompanying drawings of various embodiments of the disclosure.

FIG. 1 illustrates a perspective view of a windrower, in accordance with some embodiments of the present disclosure.

FIG. 2 illustrates a schematic diagram of a control system of the windrower of FIG. 1, in accordance with some embodiments of the present disclosure.

FIG. 3, illustrates another schematic diagram of a control system of an agricultural dual-path machine, such as the windrower of FIG. 1, in accordance with some embodiments of the present disclosure.

FIGS. 4, 5, and 6 illustrate example methods, in accordance with some embodiments of the present disclosure.

FIG. 7 illustrates a block diagram of example aspects of a computing system, in accordance with some embodiments of the present disclosure.

### DETAILED DESCRIPTION OF EXAMPLE EMBODIMENTS

Details of example embodiments of the invention are described in the following detailed description with reference to the drawings. Although the detailed description provides reference to example embodiments, it is to be understood that the invention disclosed herein is not limited to such example embodiments. But to the contrary, the invention disclosed herein includes numerous alternatives, modifications and equivalents as will become apparent from consideration of the following detailed description and other parts of this disclosure.

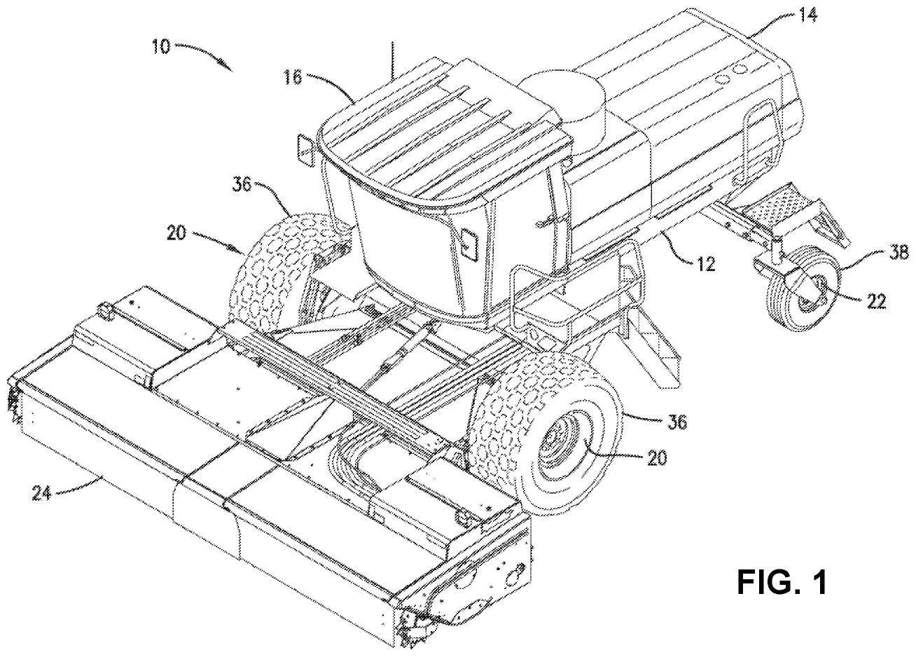

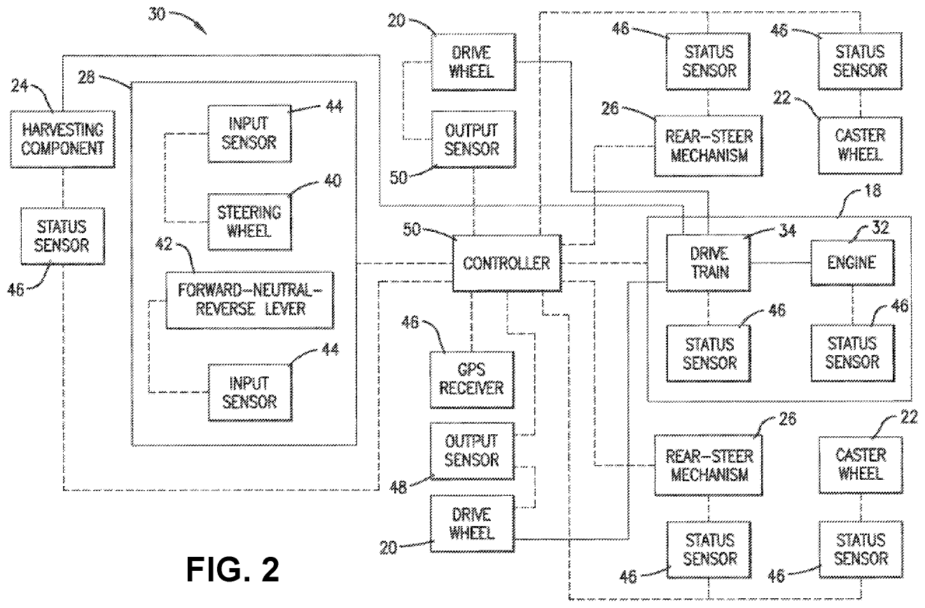

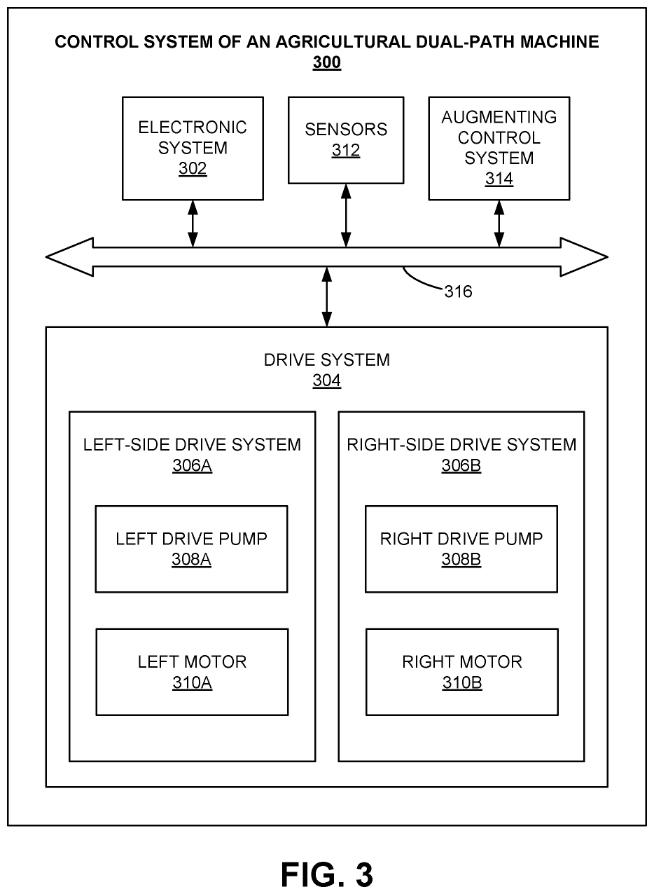

With respect to FIGS. 1 and 2, a dual-path windrower (hereinafter referenced as the dual-path agricultural machine 10) in which a control system of the present disclosure can be incorporated is illustrated. Some embodiments includes the dual-path agricultural machine 10 and its control system. In some embodiments, the control system of the dual-path agricultural machine 10 can be or include the control system 300 shown in FIG. 3.

The dual-path agricultural machine 10 includes a chassis 12, an engine compartment 14, a cab 16, a drive system 18, drive wheels 20, a set of caster wheels 22, a harvesting component 24, a set of rear-steer mechanisms 26, a number of user drive input mechanisms 28, and the aforementioned control system (hereinafter referred to as control system 30).

The chassis 12 supports the engine compartment 14, cab 16, harvesting component 24 and drive system 18 and can include a number of frame rails, cross beams, and other structural members. The chassis 12 can also include a number of mounting bosses or mounting points for mounting the components to the chassis 12.

The engine compartment 14 encloses the engine and other components of the drive system 18 and is mounted on the chassis 12 behind the cab 16. The engine compartment 14 can include doors and/or removable access panels for servicing the engine.

The cab 16 protects a user (hereinafter “driver”) and the user drive input mechanisms 28 from outside elements and can include an enclosed canopy having a door and several windows or windshields. A seat and other ergonomic features from which the driver can control the dual-path agricultural machine 10 can be positioned in the cab 16. Alternatively, the user input mechanisms can be a user interface for the selection of control input from a remote or automated source such as GPS waylines or more advanced autonomous drive control.

The drive system 18 powers the drive wheels 20 and the harvesting component 24 and includes an engine 32 and a drive train 34. In some embodiments, the drive system 18 also powers the rear-steer mechanisms 26. The engine 32 can be a gasoline or diesel internal combustion engine or any other suitable power source. The drive train 34 transfers power from the engine 32 to the drive wheels 20 and can include drive shafts, drive belts, gear boxes, and the like. The drive train 34 can also include hydraulic or pneumatic lines, valves, and the like.

The drive wheels 20 are large driven wheels that can include drive tires 36 mounted thereon. The drive tires 36 can include traction lugs or other features for improved grip. These could also be replaced with tracks on some agricultural machines. The drive wheels 20 can be positioned near a front end of the chassis 12 and can support a majority of the weight of the dual-path agricultural machine 10. The drive wheels 20 can be non-steerable and independently driven.

The caster wheels 22 are small non-driven wheels spaced behind the drive wheels 20 and can include non-drive tires 38 mounted thereon. The non-drive tires 38 can have annular ridges and/or grooves for allowing the non-drive tires 38 to more easily pass over mud, loose dirt, gravel, and other ground conditions. The caster wheels 22 can be configured to swivel about a vertically extending axis in either a free-wheeling mode or a steering mode. In another embodiment, the caster wheels 22 are “front casters” spaced in front of the drive wheels 20. The non-drive tires 38 are not limited to being non-driven and can have hydraulic or electric assist.

The harvesting component 24 cuts and swaths crops into a windrow and can be removably attached to the front end of the chassis 12. The harvesting component 24 can be driven by the drive system 18 via an auxiliary or power take-off (PTO) drive.

The rear-steer mechanisms 26 actuate the caster wheels 22 in select situations and can include tie rods, rack-and-pinion mechanisms, hydraulics, pneumatics, rotary motors, or any other suitable actuation components. In some embodiments, the rear-steer mechanisms 26 are configured to be engaged with and disengaged from the caster wheels 22. The rear-steer mechanisms 26 can be operated independently from each other or linked together. In another embodiment, the rear-steer mechanism 26 is a single rear-steer mechanism and actuates both caster wheels 22.

The user drive input mechanisms 28 allow the driver to provide user drive inputs and can include a steering wheel 40 and a forward-neutral-reverse lever 42. Alternatively, the user drive input mechanisms 28 can include handlebars, an acceleration pedal, a brake pedal, a yoke, a joystick, and other inputs. The user drive input mechanisms 28 can also include virtual controls implemented on a display screen of a computing device. The computing device can be integrated into the dual-path agricultural machine 10 or can be an external device such as a smartphone, tablet, or remote control.

The control system 30 controls the drive system 18, drive wheels 20, harvesting component 24, and rear-steer mechanisms 26 and includes a number of input sensors 44, a number of status sensors 46, a number of output sensors 48, and controller 50. The control system 30 can be completely integrated into the dual-path agricultural machine 10 or can incorporate external components such as a driver's smartphone or tablet or other portable or remote or onboard control devices. The controller implements a stability control mode and a selective rear-steer engagement and actuation mode.

The input sensors 44 interface with the user drive input mechanisms 28 and can include a steering wheel sensor for sensing an angle of the steering wheel 40, a forward-neutral-reverse sensor for sensing a position of the forward-neutral-reverse lever 42, and any other suitable input sensors depending on the number and type of drive input mechanisms. The input sensors 44 can be switches, electrical resistance sensors, temperature sensors, touch sensors capacitance sensors, position sensors, angle sensors, speed sensors, proximity sensors, Hall-effect sensors, accelerometers, gyroscopes, pressure sensors, time-of-flight sensors, optical sensors, imaging sensors, cameras, and the like.

The status sensors 46 interface with the drive wheels 20, the caster wheels 22, the harvesting component 24, the drive system 18, the rear-steer mechanisms 26, and/or the user drive input mechanisms 28 for sensing statuses of the interfaced devices. Alternatively, some of the status sensors 46 can be standalone for sensing a status of the dual-path agricultural machine 10 as a whole. The status sensors 46 can be switches, electrical current sensors, electrical resistance sensors, temperature sensors, capacitance sensors, position sensors, angle sensors, speed sensors, proximity sensors, inductive sensors, Hall-effect sensors, compass, inertial sensors, accelerometers, gyroscopes, pressure sensors, viscosity sensors, composition sensors, fluid flow sensors, acoustic sensors, wave interference sensors, radio receivers, GPS receivers, radar sensors, time-of-flight sensors, optical sensors, imaging sensors, cameras, coil output driver diagnostics, rear-steer position sensor diagnostics, and the like.

The output sensors 48 interface with the drive wheels 20, the caster wheels 22, the harvesting component 24, the drive system 18, the rear-steer mechanisms 26, and/or the user drive input mechanisms 28 for sensing an output of the interfaced device. Alternatively, some of the output sensors 48 can be standalone for sensing an output of the dual-path agricultural machine 10 as a whole. The output sensors 48 can be switches, electrical current sensors, electrical resistance sensors, temperature sensors, capacitance sensors, position sensors, angle sensors, speed sensors, proximity sensors, inductive sensors, Hall-effect sensors, compass, inertial sensors, accelerometers, gyroscopes, pressure sensors, viscosity sensors, composition sensors, fluid flow sensors, acoustic sensors, wave interference sensors, radio receivers, GPS receivers, radar sensors, time-of-flight sensors, optical sensors, imaging sensors, cameras, engine rpm sensors, caster wheel angle sensors, drive wheel differential sensors, and the like.

The input sensors 44, status sensors 46, and output sensors 48 can be independent from each other or can have overlapping or dual purposes depending on the context. For example, an input sensor interfaced with the forward-neutral-reverse lever 42 can serve as both an input sensor (for sensing the driver's command to drive forward at 5 miles per hour) and as a status sensor (for sensing that the dual-path agricultural machine 10 is currently in forward drive).

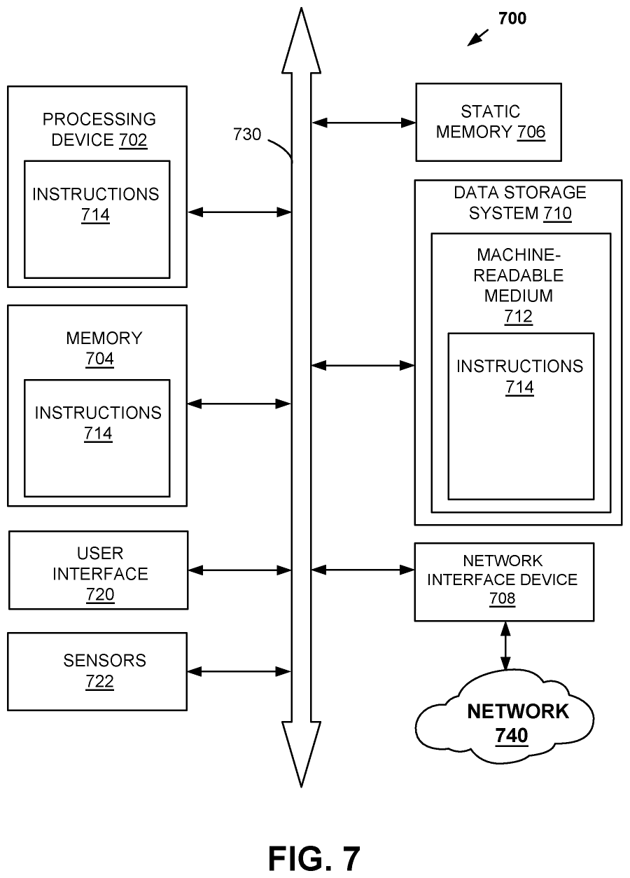

The controller 50 can include computing components such as a processor, memory, power components, and communication components for communicating with the input sensors 44, status sensors 46, output sensors 48, and other components, e.g., also see computing system 700 shown in FIG. 7. The controller 50 can perform all logic functions, or it can be divided into multiple individual controllers, each participating in the control execution. Portions of distributed control and signal processing can exist within input and output devices as well. The controller 50 can run a computer program stored in or on computer-readable medium residing on or accessible by the controller 50.

Turning to FIG. 3, shown is a control system 300 of an agricultural dual-path machine (such as the dual-path agricultural machine 10). The control system 300 can be, or include, or be a part of control system 30. The control system 300 includes an electronic system 302 (which can include or be a computing system such as the computing system 700 shown in FIG. 7).

The control system 300 includes a drive system 304 of the agricultural dual-path machine. The drive system 304 includes a left-side drive system 306A and a right-side drive system 306B. The left-side drive system 306A includes a left drive pump 308A and a left motor 310A. The right-side drive system 306B includes a right drive pump 308B and a right motor 310B. The control system 300 also includes sensors 312 of the agricultural dual-path machine and an augmenting control system 314 of the machine. The electronic system 302, the drive system 304, the sensors 312, and the augmenting control system 314 communicate with each other via a bus 316 of the control system 300.

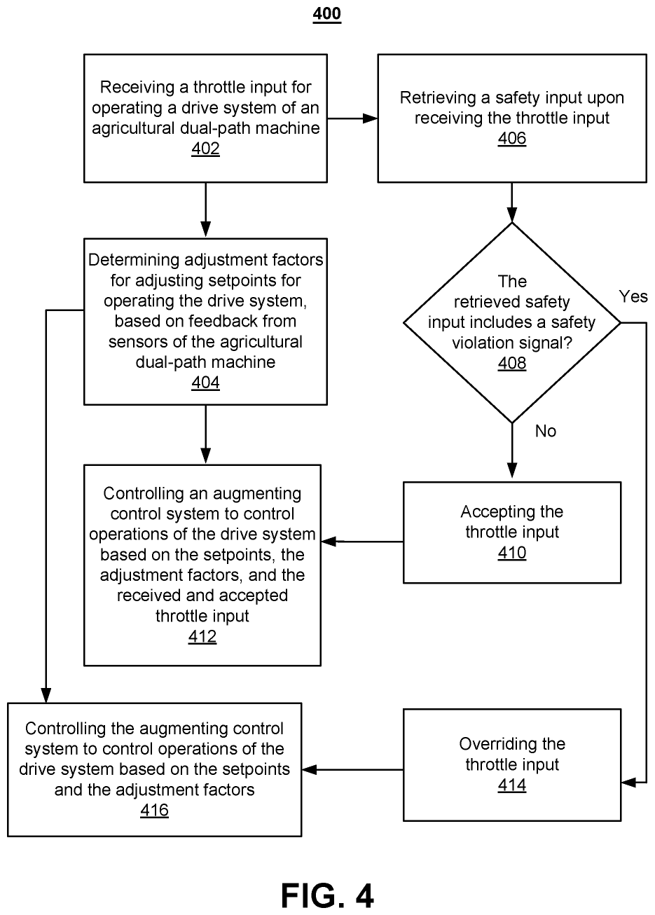

Turning to FIGS. 4, 5, and 6, shown are methods 400, 500, and 600, which can be methods of the control system 300.

As shown in FIG. 4, the method 400, at step 402, starts with receiving, by an electronic system (e.g., see electronic system 302), a throttle input for operating a drive system of an agricultural dual-path machine, e.g., see drive system 304. In some embodiments, the drive system includes a left-side drive system including a left drive pump and a left motor, and a right-side drive system including a right drive pump and a right motor (e.g., see left-side drive system 306A and right-side drive system 306B). In some embodiments of the method 400, the agricultural dual-path machine is a self-propelled windrower, such as dual-path agricultural machine 10.

The method 400, at step 404, continues with determining, by the electronic system, adjustment factors for adjusting setpoints for operating the drive system, based on feedback from sensors of the agricultural dual-path machine, e.g., see sensors 312. The method 400, at step 406, also continues with retrieving, by the electronic system, a safety input upon receiving the throttle input. In some embodiments of method 400, the setpoints include torque-to-speed ratios. Also, in some examples of the method, the left drive pump and right drive pump are variable-displacement pumps and the left motor and the right motor are variable-displacement motors.

At, step 408 of the method 400, the electronic system (such as via a computing system), determines whether or not the retrieved safety input includes a safety violation signal. In some embodiments, step 408 can merely include the occurrence or absence of a safety violation signal within the retrieved safety input and no determination is made.

As shown, at step 410, the method 400 continues with accepting, by the electronic system, the throttle input when the retrieved safety input includes an acceptable safety signal. In other words, it is determined that a safety violation signal has not occurred or in some embodiments the violation signal has merely not occurred and a corresponding component is triggered accordingly. At step 412, the method 400 continues with controlling, by the electronic system, an augmenting control system (e.g., see augmenting control system 314) to control operations of the drive system based on the received and accepted throttle input, the setpoints, and the adjustment factors.

As shown, at step 414, the method 400 continues with overriding, by the electronic system, the throttle input when the retrieved safety input includes a safety violation signal. In other words, it is determined that a safety violation signal has occurred or in some embodiments the violation signal has merely occurred and a corresponding component is triggered accordingly. At step 416, the method 400 continues with controlling, by the electronic system, the augmenting control system to control operation of the drive system based on the setpoints and the adjustment factors. In step 416, the throttle input is not used as a basis for controlling the augmenting control system.

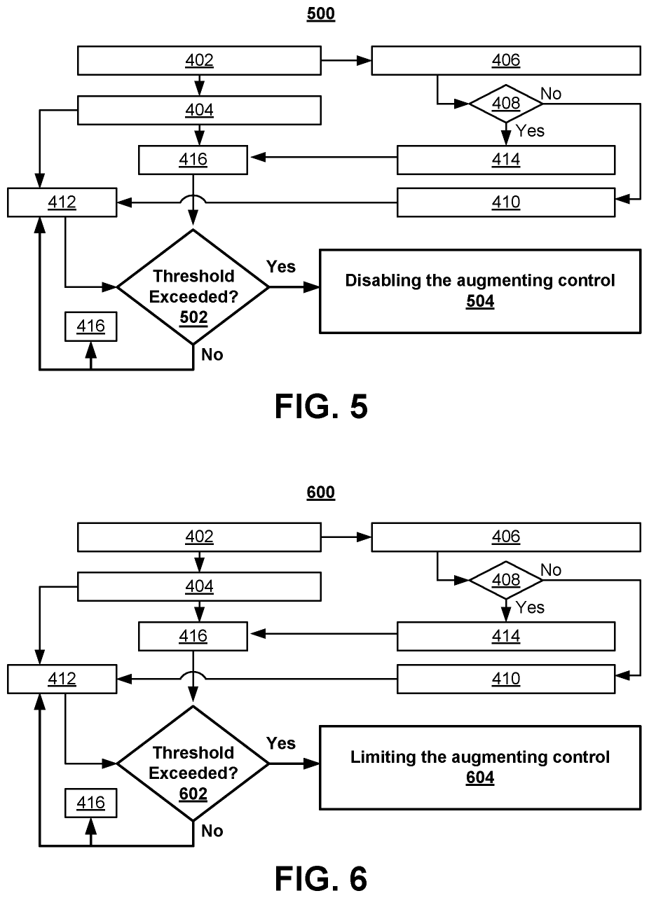

As shown in FIG. 5, the method 500 can include the steps of method 400 and additional steps 502 and 504. Step 502 includes determining whether an adjustment factor of the adjustment factors exceeds a corresponding adjustment factor threshold. Or, in some embodiments of the method, there is merely the occurrence of an adjustment factor of the adjustment factors exceeding the corresponding adjustment factor threshold. At step 504, the method 500 continues with disabling, by the electronic system, the augmenting control system to control operations of the drive system based only on the throttle input and the setpoints when the adjustment factor of the adjustment factors exceeds the corresponding adjustment factor threshold. Otherwise, the method 500 continues with controlling the augmenting control system as specified in step 412 of method 400 (controlling, by the electronic system, the augmenting control system to control operations of the drive system based on the received and accepted throttle input, the setpoints, and the adjustment factors) or step 416 of method 400 (controlling, by the electronic system, the augmenting control system to control operation of the drive system based on the setpoints and the adjustment factors).

As shown in FIG. 6, the method 600 can include the steps of method 400 and additional steps 602 and 604. Step 602 includes determining whether an adjustment factor of the adjustment factors exceeds a corresponding adjustment factor threshold. Or, in some embodiments of the method, there is merely the occurrence of the adjustment factor exceeding the corresponding adjustment factor threshold. At step 604, the method 600 continues with limiting, by the electronic system, the augmenting control system to control operations of the drive system based on the received throttle input, the setpoints, and a subset of the adjustment factors, when an adjustment factor of the adjustment factors exceeds a corresponding adjustment factor threshold. Otherwise, the method 600 continues with controlling the augmenting control system as specified in step 412 of method 400 (controlling, by the electronic system, the augmenting control system to control operations of the drive system based on the received and accepted throttle input, the setpoints, and the adjustment factors) or step 416 of method 400 (controlling, by the electronic system, the augmenting control system to control operation of the drive system based on the setpoints and the adjustment factors). In some embodiments, the subset of the adjustment factors excludes the adjustment factor that exceeded its corresponding adjustment factor threshold.

FIG. 7 shows a block diagram of example aspects of the computing system 700, which can be or be a part of any one of the electronic systems described herein (such as electronic system 302). FIG. 7 illustrates parts of the computing system 700 within which a set of instructions, for causing the machine to perform any one or more of the methodologies discussed herein, are executed. In some embodiments, the computing system 200 corresponds to a host system that includes, is coupled to, or utilizes memory or is used to perform the operations performed by any one of the computing devices, data processors, user interface devices, and sensors described herein. In alternative embodiments, the machine is connected (e.g., networked) to other machines in a LAN, an intranet, an extranet, or the Internet. In some embodiments, the machine operates in the capacity of a server or a client machine in client-server network environment, as a peer machine in a peer-to-peer (or distributed) network environment, or as a server or a client machine in a cloud computing infrastructure or environment. In some embodiments, the machine is a personal computer (PC), a tablet PC, a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computing system 700 includes a processing device 702, a main memory 704 (e.g., read-only memory (ROM), flash memory, dynamic random-access memory (DRAM), etc.), a static memory 706 (e.g., flash memory, static random-access memory (SRAM), etc.), and a data storage system 710, which communicate with each other via a bus 730.

The processing device 702 represents one or more general-purpose processing devices such as a microprocessor, a central processing unit, or the like. More particularly, the processing device is a microprocessor or a processor implementing other instruction sets, or processors implementing a combination of instruction sets. Or, the processing device 702 is one or more special-purpose processing devices such as an application specific integrated circuit (ASIC), a field programmable gate array (FPGA), a digital signal processor (DSP), network processor, or the like. The processing device 702 is configured to execute instructions 714 for performing the operations discussed herein. In some embodiments, the computing system 700 includes a network interface device 708 to communicate over a communications network 740 shown in FIG. 7.

The data storage system 710 includes a machine-readable storage medium 712 (also known as a computer-readable medium) on which is stored one or more sets of instructions 714 or software embodying any one or more of the methodologies or functions described herein. The instructions 714 also reside, completely or at least partially, within the main memory 704 or within the processing device 702 during execution thereof by the computing system 700, the main memory 704 and the processing device 702 also constituting machine-readable storage media.

In some embodiments, the instructions 714 include instructions to implement functionality corresponding to any one of the computing devices, data processors, user interface devices, I/O devices, and sensors described herein. While the machine-readable storage medium 712 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Also, as shown, computing system 700 includes user interface 720 that includes a display, in some embodiments, and, for example, implements functionality corresponding to any one of the user interface devices disclosed herein. A user interface, such as user interface 720, or a user interface device described herein includes any space or equipment where interactions between humans and machines occur. A user interface described herein allows operation and control of the machine from a human user, while the machine simultaneously provides feedback information to the user. Examples of a user interface (UI), or user interface device include the interactive aspects of computer operating systems (such as graphical user interfaces), machinery operator controls, and process controls. A UI described herein includes one or more layers, including a human-machine interface (HMI) that interfaces machines with physical input hardware and output hardware.

Also, as shown, computing system 700 includes sensors 722 that implement functionality corresponding to any one of the sensors disclosed herein. In some embodiments, the sensors 722 include a camera or another type of optical instrument that implement functionality of a camera in any one of the methodologies described herein. In some embodiments, the sensors 722 include a device, a module, a machine, or a subsystem that detect objects, events or changes in its environment and send the information to other electronics or devices, such as a computer processor or a computing system in general. In some embodiments, the sensors 722 additionally include a position sensor, a linear displacement sensor, an angular displacement sensor, a pressure sensor, a load cell, or any other sensor useable to sense a physical attribute of an agricultural vehicle related to driving and steering of the vehicle, or any combination thereof.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a predetermined result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that these and similar terms are to be associated with the appropriate physical quantities and are merely convenient labels applied to these quantities. The present disclosure can refer to the action and processes of a computing system, or similar electronic computing device, which manipulates and transforms data represented as physical (electronic) quantities within the computing system's registers and memories into other data similarly represented as physical quantities within the computing system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computing system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computing system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

While the invention has been described in conjunction with the specific embodiments described herein, it is evident that many alternatives, combinations, modifications and variations are apparent to those skilled in the art. Accordingly, the example embodiments of the invention, as set forth herein are intended to be illustrative only, and not in a limiting sense. Various changes can be made without departing from the spirit and scope of the invention.

1. A method, comprising:
receiving, by an electronic system, a throttle input for operating a drive system of an agricultural dual-path machine, the drive system comprising:
a left-side drive system comprising a left drive pump and a left motor; and
a right-side drive system comprising a right drive pump and a right motor;
determining, by the electronic system, adjustment factors for adjusting setpoints for operating the drive system, based on feedback from sensors of the agricultural dual-path machine; and
controlling, by the electronic system, an augmenting control system to control operations of the drive system based on the received throttle input, the setpoints, and the adjustment factors.

2. The method of claim 1, wherein the agricultural dual-path machine is a self-propelled windrower.

3. The method of claim 1, wherein the setpoints comprise torque-to-speed ratios.

4. The method of claim 3, wherein the left drive pump and the right drive pump are variable-displacement pumps, and wherein the left motor and the right motor are variable-displacement motors.

5. The method of claim 1, comprising disabling, by the electronic system, the augmenting control system to control operations of the drive system based only on the throttle input and the setpoints when an adjustment factor of the adjustment factors exceeds a corresponding adjustment factor threshold.

6. The method of claim 1, comprising limiting, by the electronic system, the augmenting control system to control operations of the drive system based on the received throttle input, the setpoints, and a subset of the adjustment factors, when an adjustment factor of the adjustment factors exceeds a corresponding adjustment factor threshold.

7. The method of claim 6, wherein the subset of the adjustment factors excludes the adjustment factor that exceeded its corresponding adjustment factor threshold.

8. The method of claim 1, comprising
retrieving, by the electronic system, a safety input upon receiving the throttle input;
overriding, by the electronic system, the throttle input when the retrieved safety input comprises a safety violation signal;
accepting, by the electronic system, the throttle input when the retrieved safety input comprises an acceptable safety signal; and
controlling, by the electronic system, the augmenting control system to control operations of the drive system based on the received and accepted throttle input, the setpoints, and the adjustment factors.

9. The method of claim 8, comprising disabling, by the electronic system, the augmenting control system to control operations of the drive system based only on the throttle input and the setpoints when an adjustment factor of the adjustment factors exceeds a corresponding adjustment factor threshold.

10. The method of claim 8, comprising limiting, by the electronic system, the augmenting control system to control operations of the drive system based on the received throttle input, the setpoints, and a subset of the adjustment factors, when an adjustment factor of the adjustment factors exceeds a corresponding adjustment factor threshold.

11. The method of claim 10, wherein the subset of the adjustment factors excludes the adjustment factor that exceeded its corresponding adjustment factor threshold.

12. A non-transitory computer readable storage medium comprising computer program instructions configured to instruct a computer processor to perform at least the steps of:
receiving, by a computing system, a throttle input for operating a drive system of an agricultural dual-path machine, the drive system comprising:
a left-side drive system comprising a left drive pump and a left motor; and
a right-side drive system comprising a right drive pump and a right motor;
determining, by the computing system, adjustment factors for adjusting setpoints for operating the left drive pump, the left motor, the right drive pump, and the right motor, based on feedback from sensors of the agricultural dual-path machine; and
controlling, by the computing system, an augmenting control system to control operations of the left drive pump, the left motor, the right drive pump, and the right motor based on the received throttle input, the setpoints, and the adjustment factors.

13. The non-transitory computer readable storage medium of claim 12, wherein the setpoints comprise torque-to-speed ratios.

14. The non-transitory computer readable storage medium of claim 13, wherein the left drive pump and the right drive pump are variable-displacement pumps, the left motor and the right motor are variable-displacement motors.

15. The non-transitory computer readable storage medium of claim 12, comprising disabling, by the computing system, the augmenting control system to control operations of the left drive pump, the left motor, the right drive pump, and the right motor based only on the throttle input and the setpoints when an adjustment factor of the adjustment factors exceeds a corresponding adjustment factor threshold.

16. The non-transitory computer readable storage medium of claim 12, comprising limiting, by the computing system, the augmenting control system to control operations of the left drive pump, the left motor, the right drive pump, and the right motor based on the received throttle input, the setpoints, and a subset of the adjustment factors, when an adjustment factor of the adjustment factors exceeds a corresponding adjustment factor threshold.

17. The non-transitory computer readable storage medium of claim 16, wherein the subset of the adjustment factors excludes the adjustment factor that exceeded its corresponding adjustment factor threshold.

18. The non-transitory computer readable storage medium of claim 12, comprising
retrieving, by the computing system, a safety input upon receiving the throttle input;
overriding, by the computing system, the throttle input when the retrieved safety input comprises a safety violation signal;
accepting, by the computing system, the throttle input when the retrieved safety input comprises an acceptable safety signal; and
controlling, by the computing system, the augmenting control system to control operations of the left drive pump, the left motor, the right drive pump, and the right motor based on the received and accepted throttle input, the setpoints, and the adjustment factors.

19. The non-transitory computer readable storage medium of claim 18, comprising limiting, by the computing system, the augmenting control system to control operations of the left drive pump, the left motor, the right drive pump, and the right motor based on the received throttle input, the setpoints, and a subset of the adjustment factors, when an adjustment factor of the adjustment factors exceeds a corresponding adjustment factor threshold, and wherein the subset of the adjustment factors excludes the adjustment factor that exceeded its corresponding adjustment factor threshold.

20. A computing device, comprising: at least one processor; and a storage medium tangibly storing thereon program logic configured to instruct the at least one processor to at least:
receive a throttle input for operating a drive system of a self-propelled windrower, the drive system comprising:
a left-side drive system comprising a left drive pump and a left motor; and
a right-side drive system comprising a right drive pump and a right motor;
determine adjustment factors for adjusting setpoints for operating the drive system, based on feedback from sensors of the self-propelled windrower; and
control an augmenting control system to control operations of the drive system based on the received throttle input, the setpoints, and the adjustment factors.
